(19) United States
(12) Patent Application Publication
(10) Pub. No.: US 2022/0025244 A1
(43) Pub. Date: Jan. 27, 2022

(54) NATURAL GAS HYDRATE INHIBITOR

(71) Applicant: GUANGZHOU INSTITUTE OF ENERGY CONVERSION, CHINESE ACADEMY OF SCIENCES, Guangzhou (CN)

(72) Inventors: Cuiping TANG, Guangzhou (CN); Deqing LIANG, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 17/311,696

(22) PCT Filed: Dec. 27, 2018
(86) PCT No.: PCT/CN2018/124194

§ 371 Date: Jun. 8, 2021

(30) Foreign Application Priority Data
Dec. 11, 2018 (CN) 201811508142.3

(51) Int. Cl. C09K 8/52; C08F 126/10; F17D 1/17

(52) U.S. Cl. CPC C09K 8/52; C08F 126/10; C09K 2208/22; C08F 2810/00; F17D 1/17

(57) ABSTRACT

A natural gas hydrate inhibitor having a structure of formula (1) or formula (2). The inhibitor of the present invention is synthesized on the basis of N-vinylpyrrolidone by introducing a new structural group to achieve terminal modification of the polymer chain, which thereby improves the inhibitory effect.

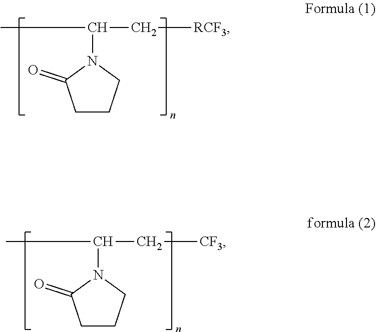

wherein R is a C₁₋₈ hydrocarbon group.

### CROSS REFERENCE TO THE RELATED APPLICATIONS

This application is the national phase entry of International Application No. PCT/CN2018/124194, filed on Dec. 27, 2018, which is based upon and claims priority to Chinese Patent Application No. 201811508142.3, filed on Dec. 11, 2018, the entire contents of which are incorporated herein by reference.

### TECHNICAL FIELD

The present invention relates to the technical field of chemical engineering, and particularly relates to a natural gas hydrate inhibitor.

### BACKGROUND

During the exploitation and transportation of oil and gas, light components in natural gas and crude oil will interact with water under low temperature and high pressure to form natural gas hydrates. Natural gas hydrates are clathrate crystals that may cause blockage in pipelines and devices and thereby bring about serious safety problems. Natural gas hydrates easily formed under low temperature and high pressure; for example, at a temperature of 4° C., the hydrate formation pressure is about 3.8 MPa for methane, about 0.8 MPa for ethane, or about 0.4 MPa for propane. These temperature and pressures are common in the production and transportation of natural gas and other petroleum fluids.

Conventionally used thermodynamic inhibitors, such as methanol and glycol, prevent the formation of hydrates by changing the thermodynamic conditions of hydrate formation. However, due to their disadvantages such as high effective concentrations (10 wt % to 60 wt %), high cost, and environmental toxicity, these inhibitors sometimes can no longer meet the requirements for marine exploitation. Ever since the 1990s, studies have been focus on novel inhibitors with low effective concentrations for replacing the thermodynamic inhibitors such as methanol.

Instead of changing the formation conditions of hydrates, these inhibitors with low effective concentrations take effect by slowing down the nucleation or growth of hydrates. Since they take effect at very low concentrations (usually below 1 wt %), the cost will be relatively low. However, use of these inhibitors in current techniques will bring huge sunk cost to equipments designed for alcohol type inhibitors. Also, economical and effective inhibitors of this type are still been developing.

### SUMMARY

One object of the present invention is to provide a natural gas hydrate inhibitor by terminal modification to existing inhibitors, in order to improve the inhibitory performance and modify the solubility, and thereby solve the prior art problems.

The natural gas hydrate inhibitor provided in the present invention has a structure of formula (1) or formula (2):

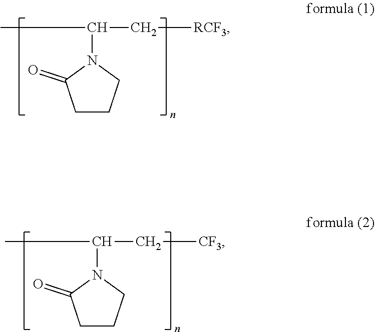

wherein R is a C₁₋₈ hydrocarbon group.

The inhibitor of the present invention is synthesized on the basis of N-vinylpyrrolidone by introducing a new structural group to achieve terminal modification of the polymer chain, which thereby improves the inhibitory effect.

Preferably, R is a phenylene group or a 1-methylcyclopentylene group.

A method for producing the above natural gas hydrate inhibitor comprises: adding N-vinylpyrrolidone and azobisisobutyronitrile to a reactor, wherein a mass ratio of N-vinylpyrrolidone to azobisisobutyronitrile is 50-60:1; adding trifluoromethylbenzene (or 1-trifluoromethyl-3-methyl-cyclopentane, or trifluoroethane) and N,N-dimethylformamide to the reactor under a nitrogen atmosphere; reacting at 75° C. to 85° C. for 6-8 hours under stirring to obtain a product; naturally cooling the product, removing N,N-dimethylformamide from the product by rotary evaporation, and subjecting the product to suction filtration with ether to obtain a solid; subjecting the solid to a drying process and a water removing process to obtain the natural gas hydrate inhibitor.

The natural gas hydrate inhibitor proposed in the present invention is featured by its simple preparation method and easily available starting materials, making it possible to carry out technology transfer.

The present invention also provides the use of the above natural gas hydrate inhibitor, wherein the natural gas hydrate inhibitor is used at a concentration of 0.5-3 wt % relative to water in the system, a pressure of 6-25 MPa, and a temperature of 2° C. to 4° C.

Compared with the prior art, the present invention has the following advantages: the present invention realizes the improvement in inhibitory effect on the basis of N-vinylpyrrolidone by introducing a new structural group to achieve terminal modification of the polymer chain.

### DETAILED DESCRIPTION OF THE EMBODIMENTS

The following examples are to further illustrate the present invention, but not to limit the present invention.

### Example 1

### Preparation of a Novel Inhibitor by Terminal Modification of Poly(N-vinylpyrrolidone) Using Trifluoromethylbenzene

352 mg of azobisisobutyronitrile as the initiator and 20.0 g of N-vinylpyrrolidone were added to a three-neck flask provided with a thermometer, a reflux condenser, and a nitrogen gas pipe. The flask was then sealed with rubber plugs, and purged with nitrogen for three times to remove the air from the flask. Under a nitrogen atmosphere, 560 μL of trifluoromethylbenzene and 100 mL of N,N-dimethylformamide were added into the flask using syringes, followed by nitrogen purging for three more times. Then, under the nitrogen atmosphere and a 200 r/min magnetic stirring, the temperature was adjusted to 80° C. to allow reaction for 7 hours. The product was a transparent liquid. After the product was naturally cooled down, a rotary evaporation process was carried out to remove most N,N-dimethylformamide from the product. The product was naturally cooled down again and then added dropwise to 1000 mL of ether (about 0° C.), followed by a suction filtration process to obtain a solid product. The solid product was placed in a vacuum oven to carry out a drying process for 48 hours (at a temperature of about 45° C.) and a water removing process for 1 hour (at a temperature of about 105° C.), and then ground for later use.

### Example 2

### Preparation of a Novel Inhibitor by Terminal Modification of Poly(N-Vinylpyrrolidone) Using Trifluoroethane

352 mg of azobisisobutyronitrile as the initiator and 20.0 g of N-vinylpyrrolidone were added to a three-neck flask provided with a thermometer, a reflux condenser, and a nitrogen gas pipe. The flask was then sealed with rubber plugs, and purged with nitrogen for three times to remove the air from the flask. Under a nitrogen atmosphere, 560 μL of trifluoroethane and 100 mL of N,N-dimethylformamide were added into the flask using syringes, followed by nitrogen purging for three more times. Then, under the nitrogen atmosphere and a 200 r/min magnetic stirring, the temperature was adjusted to 80° C. to allow reaction for 7 hours. The product was a transparent liquid. After the product was naturally cooled down, a rotary evaporation process was carried out to remove most N,N-dimethylformamide from the product. The product was naturally cooled down again and then added dropwise to 1000 mL of ether (about 0° C.), followed by a suction filtration process to obtain a solid product. The solid product was placed in a vacuum oven to carry out a drying process for 48 hours (at a temperature of about 45° C.) and a water removing process for 1 hour (at a temperature of about 105° C.), and then ground for later use.

### Example 3

### Preparation of a Novel Inhibitor by Terminal Modification of poly(N-vinylpyrrolidone) Using 1-trifluoromethyl-3-methyl-cyclopentane

352 mg of azobisisobutyronitrile as the initiator and 20.0 g of N-vinylpyrrolidone were added to a three-neck flask provided with a thermometer, a reflux condenser, and a nitrogen gas pipe. The flask was then sealed with rubber plugs, and purged with nitrogen for three times to remove the air from the flask. Under a nitrogen atmosphere, 560 μL of 1-trifluoromethyl-3-methyl-cyclopentane and 100 mL of N,N-dimethylformamide were added into the flask using syringes, followed by nitrogen purging for three more times. Then, under the nitrogen atmosphere and a 200 r/min magnetic stirring, the temperature was adjusted to 80° C. to allow reaction for 7 hours. The product was a transparent liquid. After the product was naturally cooled down, a rotary evaporation process was carried out to remove most N,N-dimethylformamide from the product. The product was naturally cooled down again and then added dropwise to 1000 mL of ether (about 0° C.), followed by a suction filtration process to obtain a solid product. The solid product was placed in a vacuum oven to carry out a drying process for 48 hours (at a temperature of about 45° C.) and a water removing process for 1 hour (at a temperature of about 105° C.), and then ground for later use.

The synthesized products were determined by Fourier transform infrared spectroscopy and carbon NMR spectroscopy. Infrared spectra confirmed the expected structures of the inhibitors obtained in Examples 1-3.

### Comparative Example 1

### Preparation of Polyvinylpyrrolidone

352 mg of azobisisobutyronitrile as the initiator and 20.0 g of N-vinylpyrrolidone were added to a three-neck flask provided with a thermometer, a reflux condenser, and a nitrogen gas pipe. The flask was then sealed with rubber plugs, and purged with nitrogen for three times to remove the air from the flask. Under a nitrogen atmosphere, 560 μL of methyl acetate and 100 mL of N,N-dimethylformamide were added into the flask using syringes, followed by nitrogen purging for three more times. Then, under the nitrogen atmosphere and a 200 r/min magnetic stirring, the temperature was adjusted to 80° C. to allow reaction for 7 hours. The product was a transparent liquid. After the product was naturally cooled down, a rotary evaporation process was carried out to remove most N,N-dimethylformamide from the product. The product was naturally cooled down again and then added dropwise to 1000 mL of ether (about 0° C.), followed by a suction filtration process to obtain a solid product. The solid product was placed in a vacuum oven to carry out a drying process for 48 hours (at a temperature of about 45° C.) and a water removing process for 1 hour (at a temperature of about 105° C.), and then ground for later use. The synthesized product was determined to be polyvinylpyrrolidone by Fourier transform infrared spectroscopy and carbon NMR spectroscopy.

### Example 4

### Assessment of Inhibitory Effect

The assessment was carried out using a device which mainly comprised: a constant-temperature air bath, a reactor, a magnetic stirrer, a data collecting module, a temperature sensor, and a pressure sensor. The reactor had a capacity of 1000 mL and a maximum allowable pressure of 25 MPa. The pressure sensor was a model CYB-20S with a precision of ±0.025 MPa. The temperature sensor was a model PT100 with a precision of ±0.1° C. The assessment employed a gas mixture of methane (95%) and propane (5%) while the inhibitor was applied at a concentration of 1%. To the reactor was introduced a prepared reaction solution of 197.0±0.5 g, and then a small amount of the gas mixture (below 1 MPa). The temperature of the reactor was then cooled down to a predetermined temperature of 4° C., followed by the introduction of the gas mixture to increase the pressure to about 6 MPa. After the pressure reached 6 MPa, the gas valve of the reactor was turned off and the gas supply was cut off. The magnetic stirrer was turned off to initiate the trial. Data was collected and the reaction was under observation. When the temperature first increased and then decreased to a value maintained stable for a long period, along with a significant decrease of pressure, the trial was terminated. The inhibitory effect of different inhibitors was determined by considering the induction times of hydrate formation.

In the assessment with the above device, polyvinylpyrrolidone (a weight average molecular weight of about 900000 Da) exhibited an inhibitory time of 480 minutes (at a temperature of 4° C. and a pressure of 6 MPa, wherein a mass concentration of polyvinylpyrrolidone in the aqueous solution of polyvinylpyrrolidone was 1%); an inhibitory time of 180 minutes at a temperature of 4° C., a pressure of 15 MPa, and a mass concentration of 3%; and an inhibitory time of 15 minutes at a temperature of 2° C., a pressure of 25 MPa, and a mass concentration of 0.5%.

The natural gas hydrate inhibitors of Examples 1-3 and the polyvinylpyrrolidone of Comparative Example 1 were tested for their inhibitory effect using the above device, with the mass concentrations indicated in Table 1. Results were as shown in Table 1.

TABLE 1
Inhibitory effect of different inhibitors

| | Concentration | | Inhibitory time |
|---|---|---|---|
| | (wt %) | Conditions | (min) |
| Example 1 | 0.5 | 275.15K, 25 MPa | 80 |
| | 1 | 277.15K, 6 MPa | 1050 |
| | 3 | 277.15K, 15 MPa | 820 |
| Example 2 | 0.5 | 275.15K, 25 MPa | 30 |
| | 1 | 277.15K, 6 MPa | 850 |
| | 3 | 277.15K, 15 MPa | 230 |
| Example 3 | 0.5 | 275.15K, 25 MPa | 50 |
| | 1 | 277.15K, 6 MPa | 1200 |
| | 3 | 277.15K, 15 MPa | 560 |
| Comparative | 0.5 | 275.15K, 25 MPa | 15 |
| Example 1 | 1 | 277.15K, 6 MPa | 480 |
| | 3 | 277.15K, 15 MPa | 180 |

The above examples are preferred embodiments of the present invention, but the present invention is not limited by the examples. Any other changes, modifications, substitutions, combinations, or simplifications, made without departing from the spirit and principle of the present invention, should fall within the scope of the present invention.

What is claimed is:

1. A natural gas hydrate inhibitor, having a structure of formula (1) or formula (2): 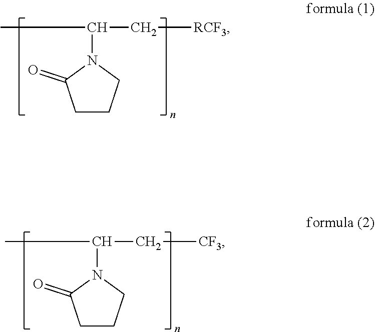
wherein R is a C₁₋₈ hydrocarbon group.

2. The natural gas hydrate inhibitor according to claim 1, wherein R is a phenylene group or a 1-methylcyclopentylene group.

3. A method of inhibiting a formation of natural gas hydrates, comprising the step of using the natural gas hydrate inhibitor of claim 1.

4. The method according to claim 3, wherein the natural gas hydrate inhibitor is used at a concentration of 0.5-3 wt % relative to water in a system, a pressure of 6-25 MPa, and a temperature of 2° C. to 4° C.
